(19) United States
(12) Patent Application Publication
(10) Pub. No.: US 2023/0156612 A1
(43) Pub. Date: May 18, 2023

(54) TECHNIQUES FOR POWER CONTROL FOR UPLINK TRANSMISSION

(71) Applicant: QUALCOMM Incorporated, San Diego, CA (US)

(72) Inventors: Tianpei CHEN, San Diego, CA (US); Tienyow LIU, Santa Clara, CA (US); Farhad MESHKATI, San Diego, CA (US); Raghu Narayan CHALLA, San Diego, CA (US); Yahia RAMADAN, San Jose, CA (US); Jing LIN, Milpitas, CA (US)

(21) Appl. No.: 18/053,990

(22) Filed: Nov. 9, 2022

Related U.S. Application Data
(60) Provisional application No. 63/264,021, filed on Nov. 12, 2021.

(51) Int. Cl. H04W 52/14; H04W 52/36; H04W 52/28

(52) U.S. Cl. CPC H04W 52/146; H04W 52/367; H04W 52/28

(57) ABSTRACT

Various aspects of the present disclosure generally relate to wireless communication. In some aspects, a user equipment (UE) may allocate, from a first amount of energy associated with a first antenna group of the UE, a second amount of energy to a first antenna port of a plurality of antenna ports associated with the first antenna group. The UE may allocate, from the first amount of energy, a third amount of energy to a second antenna port of the plurality of antenna ports associated with the first antenna group. The UE may select, based at least in part on the second amount of energy and the third amount of energy, a set of antenna ports, of the plurality of antenna ports, for an uplink transmission. The UE may perform the uplink transmission using the selected set of antenna ports. Numerous other aspects are described.

### CROSS-REFERENCE TO RELATED APPLICATION

This patent application claims priority to U.S. Provisional Patent Application No. 63/264,021, filed on Nov. 12, 2021, entitled “TECHNIQUES FOR POWER CONTROL FOR UPLINK TRANSMISSION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for power control for uplink transmission.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation (CA). As the demand for mobile broadband access continues to increase, further improvements in LTE, NR, and other radio access technologies remain useful.

### SUMMARY

Some aspects described herein relate to a method of wireless communication performed by a user equipment (UE). The method may include allocating, from a first amount of energy associated with a first antenna group of the UE, a second amount of energy to a first antenna port of a plurality of antenna ports associated with the first antenna group. The method may include allocating, from the first amount of energy associated with the first antenna group of the UE, a third amount of energy to a second antenna port of the plurality of antenna ports associated with the first antenna group, wherein the second amount of energy and the third amount of energy are different from one another. The method may include selecting, based at least in part on the second amount of energy and the third amount of energy, a set of antenna ports, of the plurality of antenna ports, for an uplink transmission. The method may include performing the uplink transmission using the selected set of antenna ports.

Some aspects described herein relate to a UE for wireless communication. The UE may include a memory and one or more processors coupled to the memory. The one or more processors may be configured to allocate, from a first amount of energy associated with a first antenna group of the UE, a second amount of energy to a first antenna port of a plurality of antenna ports associated with the first antenna group. The one or more processors may be configured to allocate, from the first amount of energy associated with the first antenna group of the UE, a third amount of energy to a second antenna port of the plurality of antenna ports associated with the first antenna group, wherein the second amount of energy and the third amount of energy are different from one another. The one or more processors may be configured to select, based at least in part on the second amount of energy and the third amount of energy, a set of antenna ports, of the plurality of antenna ports, for an uplink transmission. The one or more processors may be configured to perform the uplink transmission using the selected set of antenna ports.

Some aspects described herein relate to a non-transitory computer-readable medium that stores a set of instructions for wireless communication by a UE. The set of instructions, when executed by one or more processors of the UE, may cause the UE to allocate, from a first amount of energy associated with a first antenna group of the UE, a second amount of energy to a first antenna port of a plurality of antenna ports associated with the first antenna group. The set of instructions, when executed by one or more processors of the UE, may cause the UE to allocate, from the first amount of energy associated with the first antenna group of the UE, a third amount of energy to a second antenna port of the plurality of antenna ports associated with the first antenna group, wherein the second amount of energy and the third amount of energy are different from one another. The set of instructions, when executed by one or more processors of the UE, may cause the UE to select, based at least in part on the second amount of energy and the third amount of energy, a set of antenna ports, of the plurality of antenna ports, for an uplink transmission. The set of instructions, when executed by one or more processors of the UE, may cause the UE to perform the uplink transmission using the selected set of antenna ports.

Some aspects described herein relate to an apparatus for wireless communication. The apparatus may include means for allocating, from a first amount of energy associated with a first antenna group of the apparatus, a second amount of energy to a first antenna port of a plurality of antenna ports associated with the first antenna group. The apparatus may include means for allocating, from the first amount of energy associated with the first antenna group of the apparatus, a third amount of energy to a second antenna port of the plurality of antenna ports associated with the first antenna group, wherein the second amount of energy and the third amount of energy are different from one another. The apparatus may include means for selecting, based at least in part on the second amount of energy and the third amount of energy, a set of antenna ports, of the plurality of antenna ports, for an uplink transmission. The apparatus may include means for performing the uplink transmission using the selected set of antenna ports.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a UE adapting transmit power over a moving integration window to satisfy one or more radio frequency (RF) radiation exposure limits, in accordance with the present disclosure.

FIG. 4 is a diagram illustrating an example of dual connectivity, in accordance with the present disclosure.

FIG. 5 is a diagram illustrating an example of real time power control, in accordance with the present disclosure.

FIG. 6 is a diagram illustrating examples of multiple input multiple output transmission using a pair of selected antennas, in accordance with the present disclosure.

FIG. 7 is a diagram illustrating an example process performed, for example, by a UE, in accordance with the present disclosure.

FIG. 8 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

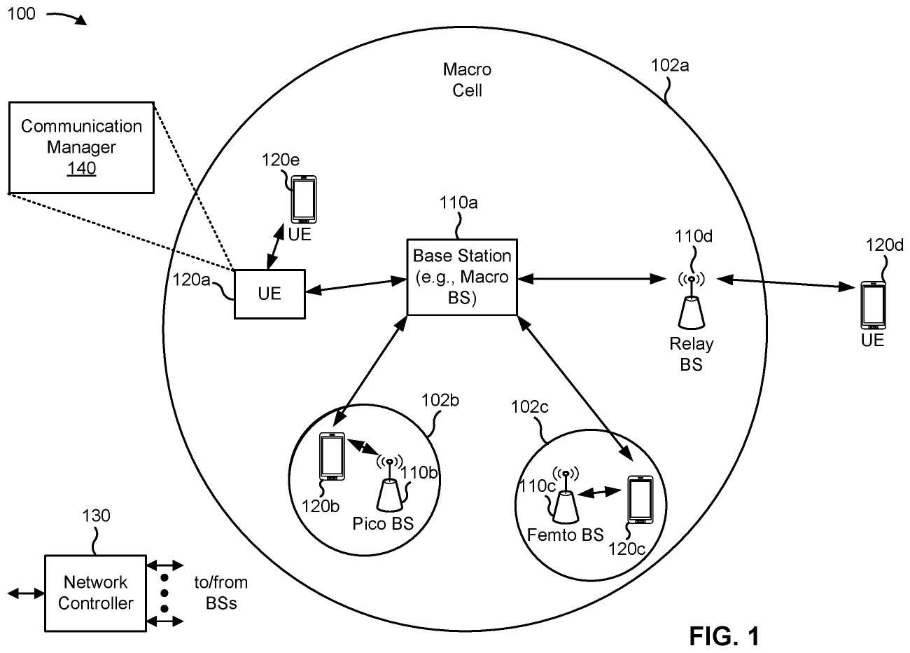

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may allocate, from a first amount of energy associated with a first antenna group of the UE, a second amount of energy to a first antenna port of a plurality of antenna ports associated with the first antenna group; allocate, from the first amount of energy associated with the first antenna group of the UE, a third amount of energy to a second antenna port of the plurality of antenna ports associated with the first antenna group, wherein the second amount of energy and the third amount of energy are different from one another; select, based at least in part on the second amount of energy and the third amount of energy, a set of antenna ports, of the plurality of antenna ports, for an uplink transmission; and perform the uplink transmission using the selected set of antenna ports. Additionally, or alternatively, the communication manager 140 may perform one or more other operations described herein.

As indicated above, FIG. 1 is provided as an example. Other examples may differ from what is described with regard to FIG. 1.

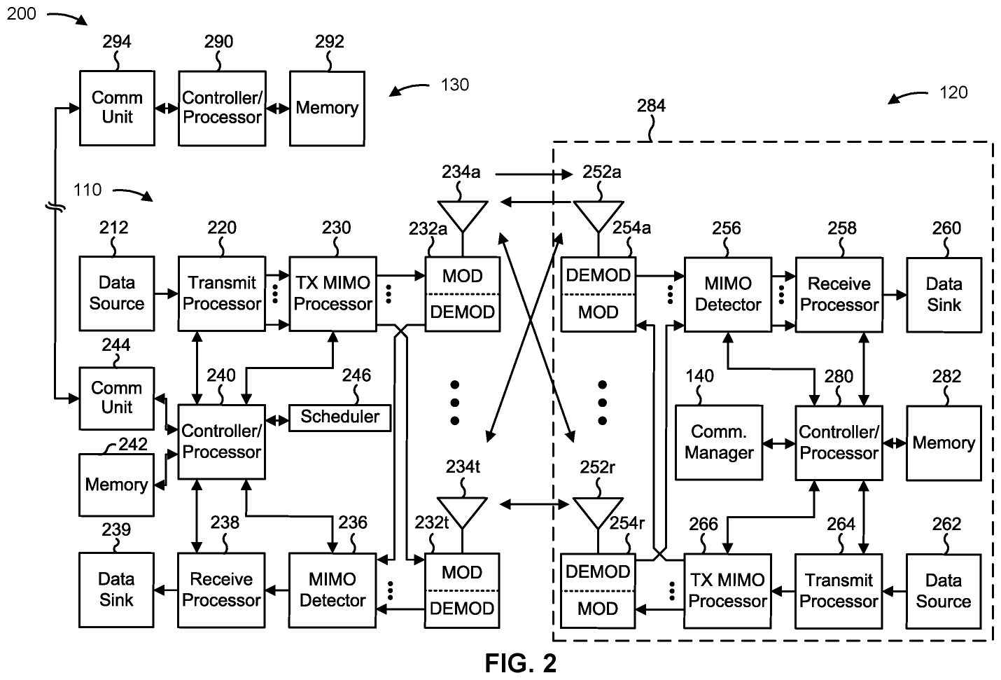

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

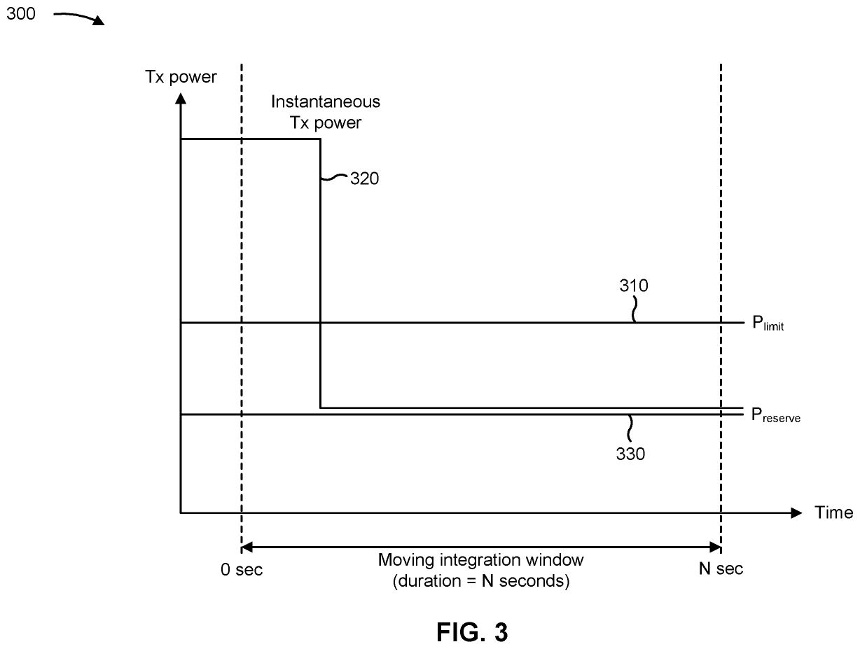

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-8).

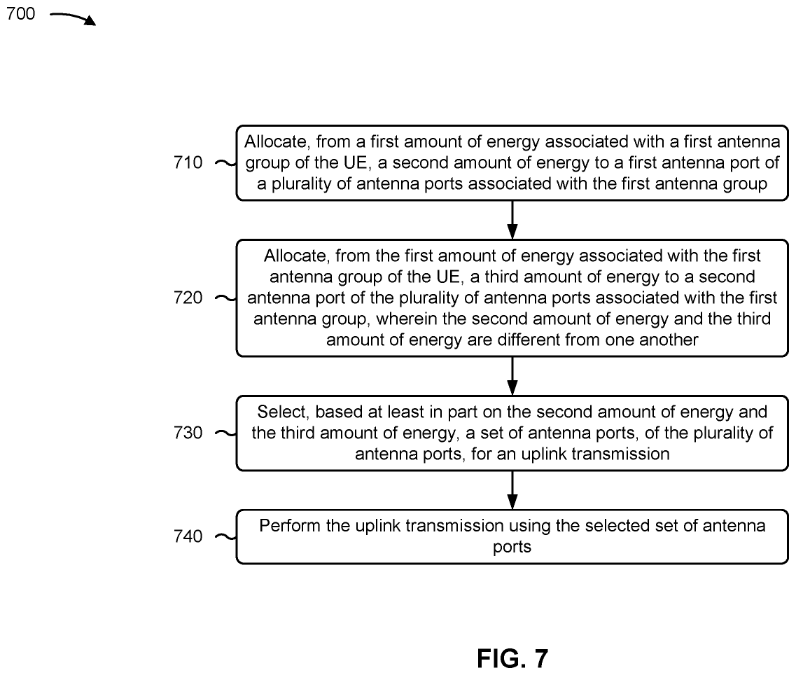

The controller/processor 240 of the base station 110, the controller/processor 280 of the UE 120, and/or any other component(s) of FIG. 2 may perform one or more techniques associated with uplink power control, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, and/or other processes as described herein. In some examples, executing instructions may include running the instructions, converting the instructions, compiling the instructions, and/or interpreting the instructions, among other examples.

In some aspects, the UE includes means for allocating, from a first amount of energy associated with a first antenna group of the UE, a second amount of energy to a first antenna port of a plurality of antenna ports associated with the first antenna group; means for allocating, from the first amount of energy associated with the first antenna group of the UE, a third amount of energy to a second antenna port of the plurality of antenna ports associated with the first antenna group, wherein the second amount of energy and the third amount of energy are different from one another; means for selecting, based at least in part on the second amount of energy and the third amount of energy, a set of antenna ports, of the plurality of antenna ports, for an uplink transmission; and/or means for performing the uplink transmission using the selected set of antenna ports. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of a UE adapting transmit power over a moving integration window to satisfy one or more radio frequency (RF) radiation exposure limits, in accordance with the present disclosure.

Because UEs may emit RF waves, microwaves, and/or other radiation, UEs are generally subject to regulatory RF safety requirements that set forth specific guidelines, or exposure limits, that constrain various operations that the UEs can perform. For example, RF emissions may generally increase when a UE is transmitting, and the RF emissions may further increase in cases where the UE is performing frequent transmissions, high-power transmissions, or the like. Accordingly, because frequent and/or high-power transmissions may lead to significant RF emissions, regulatory agencies (e.g., the Federal Communications Commission (FCC) in the United States) may provide information related to acceptable RF radiation exposure when UEs are communicating using different radio access technologies.

In some examples, RF exposure may be expressed in terms of a specific absorption rate (SAR), which measures energy absorption by human tissue per unit mass and may have units of watts per kilogram (W/kg). For example, when a UE is communicating using a RAT that operates in a frequency range below 6 GHz, the applicable RF exposure parameter may include the SAR. In particular, SAR requirements generally specify that overall radiated power by a UE is to remain under a certain level to limit heating of human tissue that may occur when RF energy is absorbed. Because SAR exposure may be used to assess RF exposure for transmission frequencies less than 6 GHz, SAR exposure limits typically cover wireless communication technologies such as 2G/3G (e.g., CDMA), 4G (e.g., 3GPP Long Term Evolution (LTE)), certain 5G bands (e.g., NR in 6 GHz bands), IEEE 802.11ac, and other wireless communication technologies.

RF exposure may also be expressed in terms of power density (PD), which measures energy absorption per unit area and may be expressed in units of mW/cm². For example, when a UE is communicating using a RAT that operates in a high frequency range, such as a millimeter wave (mmW) frequency range, the applicable RF exposure parameter is PD, which may be regulated to limit heating of the UE and/or nearby surfaces. In certain cases, a maximum permissible exposure (MPE) limit in terms of PD may be imposed for wireless communication devices using transmission frequencies above 6 GHz. The MPE limit is a regulatory metric for exposure based on area, such as an energy density limit defined as a number, X, of watts per square meter (W/m²) averaged over a defined area and time-averaged over a frequency-dependent time window to prevent a human exposure hazard represented by a tissue temperature change. Because PD limits are typically used to assess RF exposure for transmission frequencies higher than 10 GHz, PD limits typically cover wireless communication technologies such as IEEE 802.11ad, 802.11ay, certain 5G bands (e.g., mmWave bands), and other wireless communication technologies.

Accordingly, different metrics may be used to assess RF exposure for different wireless communication technologies. UEs generally must satisfy all applicable RF exposure limits (e.g., SAR exposure limits or PD (e.g., MPE) exposure limits), which are typically regulatory requirements that are defined in terms of aggregate exposure over a certain amount of time, and the aggregate exposure may be averaged over a moving integration window (or moving time window), sometimes referred to as a compliance window. Some RF exposure limits, such as SAR exposure limits and PD exposure limits, can be expressed in terms of energy. For example, an RF exposure limit can indicate an amount of radiated or absorbed energy that is permissible within a time window. This amount of energy can be used to identify power limits for UEs, as described below.

For example, as shown in FIG. 3, and by reference number 310, a UE may be subject to an average power limit (Pₗᵢₘᵢₜ) that corresponds to an average power at which an SAR exposure limit and/or an MPE (e.g., PD) limit is satisfied if the UE were to transmit substantially continuously over a moving integration window of N seconds (e.g., 100 seconds). Accordingly, as shown by reference number 320, the UE can use an instantaneous transmit power that exceeds the average power limit for a period of time provided that the average power over the moving integration window is under the average power limit at which the MPE limit is satisfied. For example, the UE may transmit at a maximum transmit power at the start of the moving integration window, and then reduce the instantaneous transmit power until the moving integration window ends, to ensure that the MPE limit on aggregate exposure (which may be expressed in terms of energy) is satisfied over the entire moving integration window. In general, as shown by reference number 330, the UE may reduce the instantaneous transmit power to a reserve power level (Preserve), which is a minimum transmit power level to maintain a link with a base station.

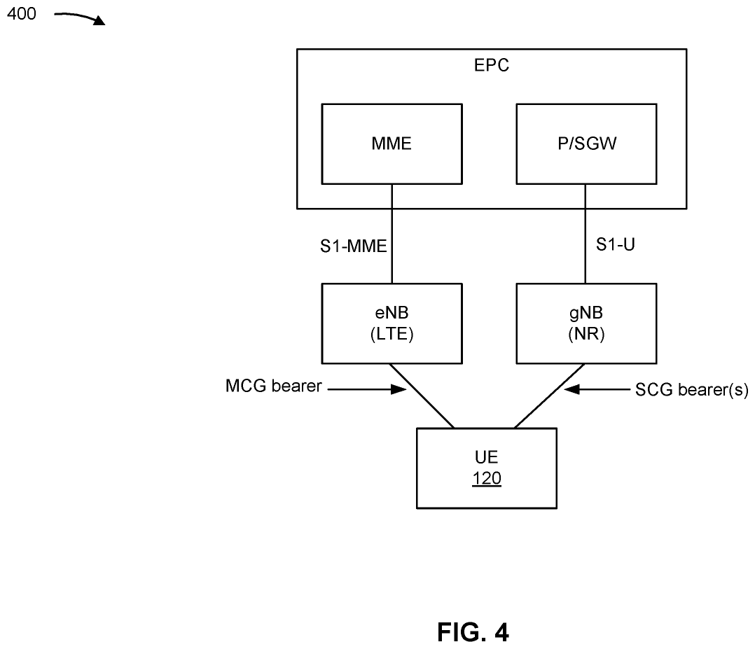

A wireless communication device (e.g., UE 120) may simultaneously transmit signals using multiple wireless communication technologies. For example, the wireless communication device may simultaneously transmit signals using a first wireless communication technology operating at or below 6 GHz (e.g., 3G, 4G, sub-6 GHz frequency bands of 5G, etc.) and a second wireless communication technology operating above 6 GHz (e.g., mmWave bands of 5G in 24 to 60 GHz bands, IEEE 802.11ad or 802.11ay). In certain cases, the wireless communication device may simultaneously transmit signals using the first wireless communication technology (e.g., 3G, 4G, 5G in sub-6 GHz bands, IEEE 802.11ac, etc.) in which RF exposure is measured in terms of SAR, and the second wireless communication technology (e.g., 5G in 24 to 60 GHz bands, IEEE 802.11ad, 802.11ay, etc.) in which RF exposure is measured in terms of PD. By way of example, a UE may include multiple radios, modules, and/or antennas (referred to collectively herein simply as radios for convenience) corresponding to multiple RATs and/or frequency bands, which may be more readily understood with reference to FIG. 4. Since the UE is required to satisfy all applicable RF exposure parameters, the UE may be subject to both SAR and MPE limitations, or may be subject to different RF exposure parameters for different radios, modules, or antenna bands, as described elsewhere herein.

As indicated above, FIG. 3 is described as an example. Other examples may differ from what is described with regard to FIG. 3.

FIG. 4 is a diagram illustrating an example 400 of dual connectivity, in accordance with the present disclosure. The example shown in FIG. 4 is for an Evolved Universal Mobile Telecommunications System Terrestrial Radio Access (E-UTRA)-NR dual connectivity (ENDC) mode. The ENDC mode is sometimes referred to as an NR or 5G non-standalone (NSA) mode. The ENDC mode is provided as one example of a scenario where a UE may implement multiple RAT technologies simultaneously, and thus may need to account for the RF exposure contribution of each RAT when satisfying any applicable RF exposure compliance limits. However, the described ENDC mode is provided merely as an example in which aspects of the technology may be employed, and in other aspects other dual connectivity modes and/or other multi-RAT communication technologies may be employed without departing from the scope of the disclosure.

In the ENDC mode, a UE 120 communicates using an LTE RAT on a master cell group (MCG), and the UE 120 communicates using an NR RAT on a secondary cell group (SCG). In some aspects, the UE 120 may communicate using dedicated radios corresponding to the multiple RATs. For example, for the ENDC mode, the UE 120 may communicate via the LTE RAT using a first radio, and the UE 120 may communicate via the NR RAT using a second radio. Moreover, aspects described herein may apply to an ENDC mode (e.g., where the MCG is associated with an LTE RAT and the SCG is associated with an NR RAT), an NR-E-UTRA dual connectivity (NEDC) mode (e.g., where the MCG is associated with an NR RAT and the SCG is associated with an LTE RAT), an NR dual connectivity (NRDC) mode (e.g., where the MCG is associated with an NR RAT and the SCG is also associated with the NR RAT), or another dual connectivity mode (e.g., where the MCG is associated with a first RAT and the SCG is associated with one of the first RAT or a second RAT). Furthermore, aspects described herein may apply to a mode where the UE 120 communicates, in addition to or instead of using one or both of the LTE RAT and/or NAT RAT, via one or more additional communication technologies, such as Wi-Fi, Bluetooth, IEEE 802.11ad, 802.11ay, or the like. Thus, as used herein, “dual connectivity mode” may refer to an ENDC mode, an NEDC mode, an NRDC mode, and/or another type of dual connectivity mode (e.g., communications using two or more connections via 2G, 3G, 4G, 4G LTE, 5G NR, 6G, Wi-Fi, Bluetooth, IEEE 802.11ad, 802.11ay, etc.).

Returning to the ENDC example, and as shown in FIG. 4, a UE 120 may communicate with both an eNB (e.g., a 4G base station 110) and a gNB (e.g., a 5G base station 110), and the eNB and the gNB may communicate (e.g., directly or indirectly) with a 4G/LTE core network, shown as an evolved packet core (EPC) that includes a mobility management entity (MME), a packet data network gateway (PGW), a serving gateway (SGW), and/or other devices. In FIG. 4, the PGW and the SGW are shown collectively as P/SGW. In some aspects, the eNB and the gNB may be co-located at the same base station 110. In some aspects, the eNB and the gNB may be included in different base stations 110 (e.g., may not be co-located).

As further shown in FIG. 4, in some aspects, a wireless network that permits operation in a 5G NSA mode may permit such operations using a master cell group (MCG) for a first RAT (e.g., an LTE RAT or a 4G RAT) and a secondary cell group (SCG) for a second RAT (e.g., an NR RAT or a 5G RAT). In this case, the UE 120 may communicate with the eNB via the MCG, and may communicate with the gNB via the SCG. In some aspects, the MCG may anchor a network connection between the UE 120 and the 4G/LTE core network (e.g., for mobility, coverage, and/or control plane information), and the SCG may be added as additional carriers to increase throughput (e.g., for data traffic and/or user plane information). In some aspects, the gNB and the eNB may not transfer user plane information between one another. In some aspects, a UE 120 operating in a dual connectivity mode may be concurrently connected with an LTE base station 110 (e.g., an eNB) and an NR base station 110 (e.g., a gNB) (e.g., in the case of ENDC or NEDC), or may be concurrently connected with one or more base stations 110 that use the same RAT (e.g., in the case of NRDC). In some aspects, the MCG may be associated with a first frequency band (e.g., a sub-6 GHz band and/or an FR1 band) and the SCG may be associated with a second frequency band (e.g., a millimeter wave band and/or an FR2 band).

The UE 120 may communicate via the MCG and the SCG using one or more radio bearers (e.g., data radio bearers (DRBs) and/or signaling radio bearers (SRBs)). For example, the UE 120 may transmit or receive data via the MCG and/or the SCG using one or more DRBs. Similarly, the UE 120 may transmit or receive control information (e.g., radio resource control (RRC) information and/or measurement reports) using one or more SRBs. In some aspects, a radio bearer may be dedicated to a specific cell group (e.g., a radio bearer may be an MCG bearer or an SCG bearer). In some aspects, a radio bearer may be a split radio bearer. A split radio bearer may be split in the uplink and/or in the downlink. For example, a DRB may be split on the downlink (e.g., the UE 120 may receive downlink information for the MCG or the SCG in the DRB) but not on the uplink (e.g., the uplink may be non-split with a primary path to the MCG or the SCG, such that the UE 120 transmits in the uplink only on the primary path). In some aspects, a DRB may be split on the uplink with a primary path to the MCG or the SCG. A DRB that is split in the uplink may transmit data using the primary path until a size of an uplink transmit buffer satisfies an uplink data split threshold. If the uplink transmit buffer satisfies the uplink data split threshold, the UE 120 may transmit data to the MCG or the SCG using the DRB.

Again, although the example 400 depicted in FIG. 4 depicts an ENDC mode as one example of how a UE 120 may utilize more than one radio and/or RAT, the disclosure is not so limited, and in other aspects the UE 120 may employ two or more radios differently than in the manner described in connection with FIG. 4. For example, a UE may include multiple radios corresponding to multiple RATs and/or frequency bands. For example, the UE may be capable of communicating using various RATs, such as 2G, 3G, 4G, 4G LTE, 5G NR, 6G, Wi-Fi, Bluetooth, IEEE 802.11ad, and/or 802.11ay. Additionally, or alternatively, the UE may be capable of communication on various frequency bands within a RAT (e.g., FR1, FR2, FR3, FR4a, FR4-1, FR4, and/or FR5). Additionally, or alternatively, in some aspects the UE may be capable of operating in modes in addition to those described in detail above including, for example, an uplink carrier aggregation (UL CA) mode, a dual subscriber identity module dual active (DSDA) mode, a WiFi plus wide-area network (WAN) mode, and the like. For each RAT and/or frequency band, the UE may include a corresponding radio configured to communicate on that RAT and/or frequency band. Moreover, in some cases, a UE may be configured to communicate using two or more radios concurrently. For example, a UE may communicate over 5G NR while simultaneously communicating via Bluetooth or a similar RAT. As another example, the UE may communicate using multiple component carriers, such as via one or more component carriers using a first radio and via one or more other component carriers using a second radio. In such instances, each individual radio may use a certain level of allocated power to transmit communications, and collectively the transmitting radios must satisfy any applicable SAR exposure and/or MPE (e.g., PD) limitations. Thus, the techniques described herein provide power control for a plurality of communication links. A communication link can be associated with a radio, a RAT, a MCG link or SCG link of a dual connectivity mode, a component carrier, a combination thereof, or the like. For example, the techniques defined herein may provide power control for a first radio using a first RAT, a second radio using a second RAT, a third radio associated with a first component carrier of a given RAT, a fourth radio associated with a second component carrier of the given RAT, and so on. In some aspects, a pair of communication links and/or radios may be implemented using any of the dual connectivity and/or multi-radio modes described above.

When a UE is transmitting using more than one radio (e.g., more than one communication link), the SAR and/or MPE contributions from each radio must collectively remain under the applicable SAR and/or MPE limits. Accordingly, for a given transmission timeframe or compliance window, a UE may allocate a portion of the total energy available for transmission (e.g., the total energy that can be utilized by the UE while remaining under the applicable SAR and/or MPE limits for the transmission timeframe) to each radio such that, collectively, the radios will not exceed the applicable SAR and/or MPE limits. Put another way, for given SAR exposure and PD limits (e.g., represented as SARₗᵢₘ and PDₗᵢₘ), the sum of the normalized SAR exposure and/or PD contributions of each radio (e.g., the SAR exposures and/or PD contribution of the radio, represented as SARᵢ and/or PDᵢ, divided by the applicable SAR exposure and/or PD limit, represented as SARₗᵢₘ and/or PDₗᵢₘ) must be less than or equal to one. Assuming that SAR exposure limits are applicable to radios operating in frequency bands below 6 GHz, and that MPE (e.g., PD) limits are applicable to radios operating in frequency bands above 6 GHz, the applicable SAR exposure and/or PD limits can be summarized as shown in the following equation:

$${\sum }_{i = 100 kHz}^{6 GHz} \frac{{SAR}_{i}}{{SAR}_{lim}} + {\sum }_{i = 6 kHz}^{300 GHz} \frac{{PD}_{i}}{{PD}_{lim}} \leq 1.$$

To maintain power output of a UE such that the UE satisfies the above condition, a total transmission energy available to the UE for a given transmission timeframe or compliance window is allocated among the various radios so that, if the radios transmit simultaneously, the collective power output remains under the applicable SAR exposure and/or MPE (e.g., PD) limits.

As mentioned above, a UE may communicate using a number of antennas. An antenna may be associated with an antenna port, such that a transmit chain of the UE can be mapped (e.g., connected) to the antenna port for transmission of the transmit chain's signaling via an associated antenna. An antenna may be associated with one or more antenna groups. For example, the UE 120 may have multiple antenna groups, and each antenna group may include one or more radios and/or antennas. For example, the antenna 252a of FIG. 2 may be categorized into a first antenna group, and the antenna 252r may be categorized into a second antenna group. In some aspects, an antenna can belong to multiple antenna groups. In some embodiments, each antenna array (e.g., each phased array) is placed in a different antenna group. The groups may be defined manually (e.g., by a designer or test operator) or in an automated fashion (e.g., by an algorithm operating prior to initialization of the device, at initialization, or during operation of the device). The groups may be established based at least in part on a physical location within the UE and/or according to a location of a user that may be exposed to RF radiation from the antenna, operating frequency, form factor, associated method of calculating RF exposure, or the like. In some aspects, the antenna groups may be defined and/or operated so as to be mutually exclusive in terms of RF exposure with any applicable RF exposure compliance metric (e.g., SAR and/or MPE), with the corresponding transmit power levels determined separately for each antenna group. Put another way, when determining whether a group of radios collectively remain under one or more applicable compliance limits, the RF transmissions from all radios belonging to a certain antenna group should be considered, while transmissions from other radios may not need to be considered. However, for any radios belonging to multiple antenna groups, the RF exposure from the radios may need to be considered for each antenna group to ensure that each antenna group remains under the applicable compliance limit(s).

In some aspects, the total amount of energy available for allocation among the various radios of the antenna group corresponds to an amount of energy that may be fully used by the antenna group and/or radios therein during the transmission timeframe while complying with any applicable RF exposure compliance limits, such as SAR exposure limits and/or MPE (e.g., PD) limits. The total amount of energy available to the antenna group for transmission during a transmission timeframe may initially be allocated among the various radios of the antenna groups using any number of techniques such as, for example, by equally distributing the amount of total available transmission energy among the radios, by allocating the transmission energy based at least in part on radio type with certain types of radios initially receiving more energy than others, by allocating energy according to past energy usage and/or future expected energy usage of the radio, or the like. Moreover, the energy allocations to each radio may be normalized (e.g., the amount of allocated energy may be divided by a total energy available for the transmission timeline) without departing from the scope of the disclosure.

Different antenna groups may have different exposure levels when transmitting uplink traffic, depending on the location of the antenna group, the relative distance to human tissue, and so on. Furthermore, within an antenna group, different antennas may have different exposure levels. A UE may select antennas for transmission, such as to facilitate multiple-input multiple-output (MIMO) communications, antenna switching to improve transmit diversity, and so on. For example, the UE may select two (or more) antennas for MIMO transmission, or may select a sequence of antennas for transmission using antenna switching. However, different antennas may be associated with different antenna groups, and each antenna group may have a different exposure level and/or energy budget. These different energy budgets may complicate the selection of antennas. For example, two antennas belonging to the same antenna group may have a different combined energy budget than two antennas belonging to different antenna groups, so treating these pairs of antennas equally for the purpose of antenna selection may lead to suboptimal antenna selection. Furthermore, antennas belonging to the same antenna group may be mandated, for MIMO communication, to have the same maximum transmit power. However, different antennas may have different exposure levels, meaning that different antennas may have different maximum transmit powers. Using a conservative approach, such as reducing the respective maximum transmit powers to be equal to a lowest maximum transmit power of the pair of antennas, may result in performance degradation.

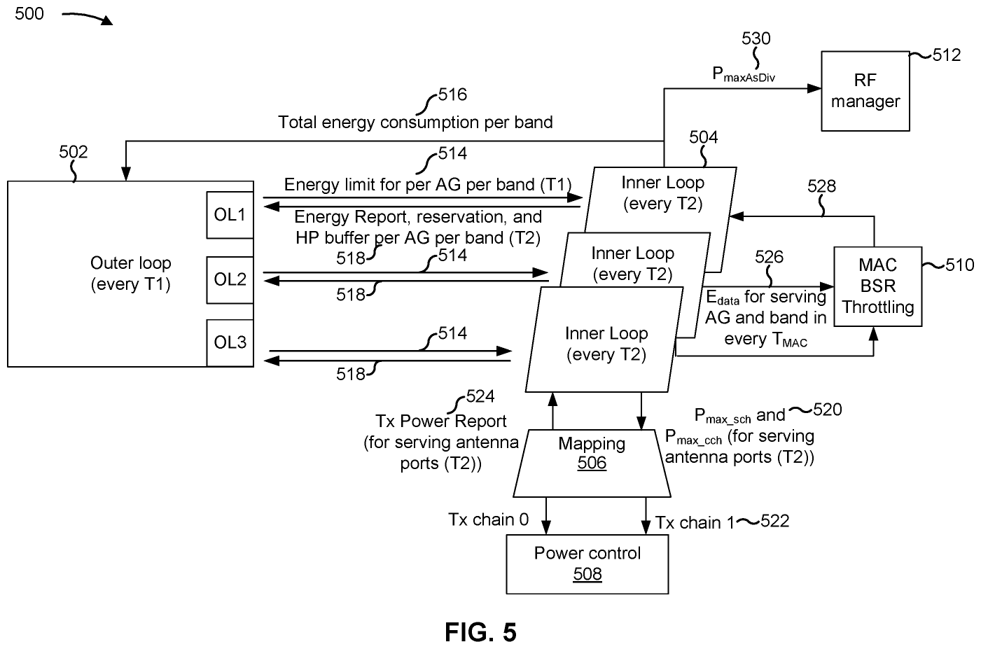

Some techniques and apparatuses described herein provide antenna selection for transmission in compliance with SAR/MPE limitations. For example, some techniques and apparatuses described herein provide selection of a set of antennas (e.g., one or more antennas, a pair of antennas, a plurality of antennas) for transmission of a communication. In some aspects, the selection may be based at least in part on respective energy budgets of one or more antenna groups associated with the set of antennas. For example, the UE may select antennas associated with one or more antenna groups such that a combined energy budget (and thus a respective maximum transmit power) of each antenna is maximized. Some techniques and apparatuses described herein provide equalization of a maximum transmit power for uplink MIMO utilizing antennas belonging to the same antenna group. For example, the UE may determine an equalization factor based at least in part on respective SAR/MPE limitations of each antenna. The selection of antennas may be based at least in part on real-time power control, which may be performed on a time scale shorter than the allocation of energy budget for each antenna group. For example, the real-time power control may involve the allocation of transmit powers for individual antennas in real time, per antenna group and per band, as described in more detail in connection with FIG. 5. In this way, antenna selection for uplink communication in accordance with SAR/MPE limitations is improved, which improves reliability and performance of uplink communication.

As indicated above, FIG. 4 is provided as an example. Other examples may differ from what is described with respect to FIG. 4.

FIG. 5 is a diagram illustrating an example 500 of real time power control, in accordance with the present disclosure. Example 500 includes various components of a UE such as UE 120. Example 500 includes a longer time window (denoted as T1) and a shorter time window (denoted as T2). “Real time” in example 500 may refer to operations performed in accordance with T2. In one example, T1 may be equal to 500 ms and T2 may be equal to 10 ms. In some aspects, T1 may be equal to the length of a compliance window.

As shown, example 500 includes an outer loop component 502, a set of inner loop components 504a-504c, a mapping component 506, an uplink power control component 508, a medium access control (MAC) component 510, and a radio frequency manager component 512. In some aspects, an inner loop component 504 may be referred to as a real-time power control (RTPC) component.

The outer loop component 502 may allocate an energy budget (sometimes referred to as an exposure budget, a normalized exposure budget or an energy limit) to an antenna group, as shown by reference number 514. For example, each antenna group of the UE may be associated with a respective outer loop component 502. In some aspects, the outer loop component 502 may allocate an energy budget per antenna group and per frequency band. For example, for a given antenna group, the outer loop component 502 may allocate a respective energy budget for each band in which the given antenna group communicates. As another example, each of the bands associated with a particular antenna group may be associated with a respective outer loop component 502. Thus, even under the same antenna group, carriers from different frequency bands can have independent exposure loops. The outer loop component 502 may allocate the energy budget at the granularity of T1. For example, the outer loop component 502 may allocate an energy budget every T1.

As shown, the outer loop component 502 may receive information from the inner loop component 504. For example, as shown by reference number 516, the outer loop component 502 may receive information indicating a total energy consumption per band (e.g., a normalized energy consumption per band). As another example, as shown by reference number 518, the outer loop component 502 may receive, from each inner loop component 504, an energy report (e.g., a normalized energy report), information indicating a dynamic reservation, information indicating a high priority buffer, or the like. The information shown by reference number 518 may be provided per antenna group and per band. In some aspects, the information shown by reference number 518 may be provided at the granularity of T2 (e.g., every T2, in real time). The energy report may indicate a total exposure usage of uplink traffic transmitted by a given antenna group in a given band. The dynamic reservation may indicate a requested energy budget (e.g., exposure budget) for high priority communications. In some aspects, a high priority communication is a communication associated with a threshold priority value, a control communication, a communication associated with a particular service, a communication associated with a particular application, or the like. By requesting the requested energy budget, the inner loop component 504 may ensure that adequate energy is allocated to support high priority communications. The high priority buffer may include an amount of energy for high priority communications if the requested energy budget associated with high priority communications is used. Thus, carriers from different frequency bands which may have critical uplink traffic (e.g., control channels) and applications (e.g., VoNR) can provide separate exposure budget requests (e.g., requested energy budgets). In this way, quality of service under inter-band carrier aggregation is improved. The outer loop component 502 may determine the energy budget shown by reference number 514 based at least in part on the information shown by reference number 518.

In some aspects, the information shown by reference number 518 may be for a serving antenna group. A serving antenna group is an antenna group that has an activated antenna port that is mapped to a transmit chain and used for uplink communication. In some aspects, the information shown by reference number 518 may be for a non-serving antenna group. In some aspects, the information shown by reference number 518 may be different for a serving antenna group than for a non-serving antenna group.

The inner loop component 504 may allocate, per band, energy for each antenna associated with a corresponding antenna group. For example, the inner loop component 504 may determine a transmit power limit (e.g., a maximum transmit power) for each antenna at the granularity of T2, where the transmit power limit is based at least in part on the allocated energy associated with each antenna. The allocated energy may prioritize power for high priority communications. For example, the allocated energy may provide sufficient power for high priority communications transmitted via a given antenna. As shown by reference number 520, the inner loop component 504 may provide, to the mapping component 506, information indicating a transmit power limit for a serving antenna port. For example, the inner loop component 504 may provide a transmit power limit for shared channels (P_{max_sch}) and/or a transmit power limit for control channels (P_{max_cch}) to the mapping component 506 at the granularity of T2 (e.g., in real time). The mapping component 506 may map a transmit chain to the serving antenna port, as shown by reference number 522 (in this example, transmit chain 1 is mapped to the serving antenna port). The uplink power control component 508 may apply the transmit power limit for uplink transmission using the serving antenna port, such as by configuring a transmitting automatic gain control component to implement the transmit power limit in real time for uplink traffic. In some aspects, as shown by reference number 524, the uplink power control component 508 and/or the mapping component 506 may provide, to the inner loop component 504, a transmit power report. The transmit power report may indicate an amount of unused transmit power or an actually used transmit power, such that the inner loop component 504 can take the unused transmit power into account for energy allocation in subsequent time windows.

As shown by reference number 526, the inner loop component 504 may provide, to the MAC component 510, information indicating an energy budget for non-high priority traffic (shown as E_{data}) (e.g., traffic associated with lower than a threshold priority level). E_{data} may represent the energy budget that is available after the dynamic reserve has been set aside. For example, the inner loop component 504 may provide this information at the granularity of a MAC time window (shown as T_{MAC}), for a serving antenna group and band. The dynamic reserve may include the amount of energy reserved for high priority communications. The MAC component 510 may determine a buffer status report (BSR) based at least in part on the information indicating the dynamic reserve. For example, the MAC component may modify a buffer status such that sufficient energy, of the energy budget allocated for a given antenna group and/or antenna, is reserved for high priority communications (sometimes referred to as BSR throttling). As shown by reference number 528, at the granularity of T1, the MAC entity may provide, to the inner loop component 504, information indicating a target transmit power (e.g., P_{target,MAC}), information indicating an increased requested target transmit power (e.g., macReqPtarget), a MAC duty cycle, or the like, for each antenna group and/or band of the UE. The target transmit power may represent the energy level that the MAC component 510 is targeting for high priority traffic (e.g., traffic associated with at least a threshold priority level). The MAC component 510 may inform the inner loop component 504 of this target power so that the inner loop component 504 can calculate the required energy of the dynamic reserve and the HP buffer, and also so that the inner loop component 504 can cap the Pmax of shared channels in accordance with P_{target,MAC} so that the Pmax does not exceed P_{target,MAC}. By this way, inner loop component provides Pmax based on what MAC needs instead of providing extra energy beyond what is needed from MAC. The information indicating the increased requested target transmit power is an indicator that, if set to true, indicates that the MAC component 510 requests more reserved energy for a specific application (e.g. VoNR), such that the inner loop component 504 can request, from the outer loop component 502, more energy in the dynamic reserve request. The MAC duty cycle indicates a duty cycle of high priority traffic so that the inner loop component 504 can determine the dynamic reserve accordingly.

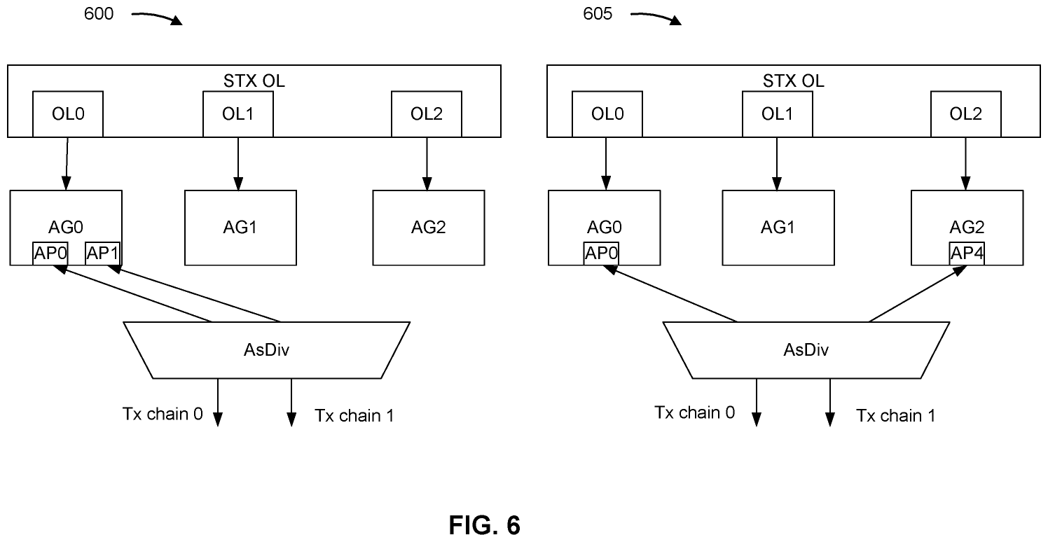

As shown by reference number 530, in some aspects, the inner loop component 504 may provide, to the RF manager component 512, information indicating a maximum transmit power for one or more antennas (P_{maxAsDiv}). The UE (e.g., the RF manager component 512) may use this information to select a set of antennas for uplink transmission, as described in more detail in connection with FIG. 6.

As indicated above, FIG. 5 is provided as an example. Other examples may differ from what is described with regard to FIG. 5.

FIG. 6 is a diagram illustrating examples 600 and 605 of MIMO transmission using a pair of selected antennas, in accordance with the present disclosure. A UE (e.g., UE 120) may select a set of antennas for uplink transmission. In some aspects, the uplink transmission may use MIMO. In a MIMO transmission, a UE concurrently transmits on two or more antennas. Example 600 shows an example where two antennas selected for MIMO transmission are associated with the same antenna group, and example 605 shows an example where two antennas selected for MIMO transmission are associated with different antenna groups. As shown, similarly to example 500, each antenna group may be associated with an outer loop (e.g., one outer loop per band and per antenna). In example 600, an antenna group 0 (AG0) includes antenna port 0 and antenna port 1 (AP0 and AP1). In example 605, an antenna group 0 (AG0) includes an antenna port 0 (AP0) and an antenna group 2 (AG2) includes an antenna port 4 (AP4). In examples 600 and 605, AG0 is a serving antenna group.

As mentioned above, an inner loop component (e.g., inner loop component 504) may provide information indicating transmit power limits (e.g., based at least in part no energy allocations) for a set of antenna ports to an RF manager component (e.g., RF manager component 512). The RF manager component may select a set of antennas (e.g., antenna ports) for an uplink transmission. For example, the RF manager component may select the set of antennas based at least in part on a combined exposure budget (e.g., a combined amount of allocated energy) of the set of antennas. In this way, the RF manager may select the set of antennas based at least in part on a joint energy allocation of the set of antennas.

As a first example, in example 600, the set of selected antennas includes AP0 and APE which are both associated with AG0. Thus, the combined exposure budget of the set of selected antennas may be equal to the exposure budget of AG0. As a second example, in example 605, the set of selected antennas includes AP0 and AP4, which are associated with different AGs. Thus, the combined exposure budget of the set of selected antennas in example 605 may be equal to the exposure budget of AG0 combined with the exposure budget of AG2 (since in example 605 there is one antenna associated with AG0 and one antenna associated with AG2, so each of these antennas would receive the full exposure budget of the corresponding AG). It can be seen that the combined exposure budget in example 605 may be higher than the combined exposure budget in example 600, since the antennas in example 605 do not need to split the exposure budget allocated for a single antenna group. Thus, the UE may jointly evaluate combinations of antennas to select antennas for a MIMO transmission.

In some aspects, the UE may select a set of antennas associated with the same antenna group for a MIMO transmission (such as in example 600). In such examples, the UE may determine an equalized transmit power for the set of antennas. For example, all APs under the same AG may share the same normalized exposure budget from an outer loop (represented by “NElimOL(AGx)”). However, different APs may have different exposure factors (represented as a normalization factor “Plim(APx)”). The exposure factor is used to scale an AP's maximum transmit power so that the AP does not violate an SAR/MPE limitation. Therefore, even though different APs may share the same normalized exposure budget, the different APs can have different maximum transmit powers due to the exposure factors.

Uplink MIMO may benefit from multiple APs having the same transmit power. If multiple activated APs are from the same AG, the UE may need to reduce the maximum transmit power of each AP in order to satisfy SAR/MPE exposure limitations, and may need to ensure balanced power for multiple activated APs. In some examples, the UE may use a minimum maximum transmit power (e.g., a lowest maximum transmit power) out of the multiple activated APs in order to keep balanced power for different activated APs, which may result in performance degradation.

In some aspects, the UE may apply an equalization factor 6 to the maximum transmit power of each activated AP separately. The equalization factor may account for the total exposure budget of the AG, and may balance the power of different activated APs under the same AG by taking the respective normalization factors of the APs into account, so that performance is improved and transmit power may be increased. For example, the equalized transmit power for each of a plurality of selected APs including AP1 and AP2, associated with AG0, may be determined as:

Pmax(AP1)=(NElimOL(AG0))/(Plim(AP1)/δ1;

Pmax(AP2)=(NElimOL(AG0))/(Plim(AP2)/δ2.

δ1 and δ2 may be selected so that Pmax(AP1) is equal to Pmax(AP2). Since the same exposure budget is used for both APs, performance for uplink MIMO may be improved relative to setting a lowest Pmax value for Pmax(AP1) and Pmax(AP2).

In some aspects, the UE may select a plurality of antennas for antenna switching. For example, the UE may select a set of antenna ports for uplink transmission. The UE may switch from antenna port to antenna port, of the set of antenna ports, in sequence. Thus, the UE may implement antenna diversity. In such examples, the UE may select the plurality of antennas based at least in part on an allocated energy associated with an antenna group (e.g., a first amount of energy or a second amount of energy), an allocated energy associated with an antenna port (e.g., a third amount of energy or a fourth amount of energy), and/or a maximum transmit power associated with an antenna port (e.g., which may be based at least in part on the third amount of energy or the fourth amount of energy).

In some aspects, in example 605, the UE may transmit a physical uplink control channel (PUCCH) via the plurality of antennas. In this example, both transmit chains (associated with the plurality of antennas) may transmit the PUCCH. The UE may prioritize the PUCCH for both antenna groups (e.g., may perform PUCCH prioritization for both antenna groups). In some aspects, such as inter-band carrier aggregation, each carrier/band is transmitted via a separate transmit chain (e.g., uplink transmitter), and in some cases, two or more carriers/bands can include a transmitted PUCCH. Therefore, the UE may prioritize PUCCH for each of the two or more carriers/bands. For example, performing the uplink transmission may include prioritizing a physical uplink control channel on each antenna group or carrier used for the uplink transmission.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with power control for uplink transmission.

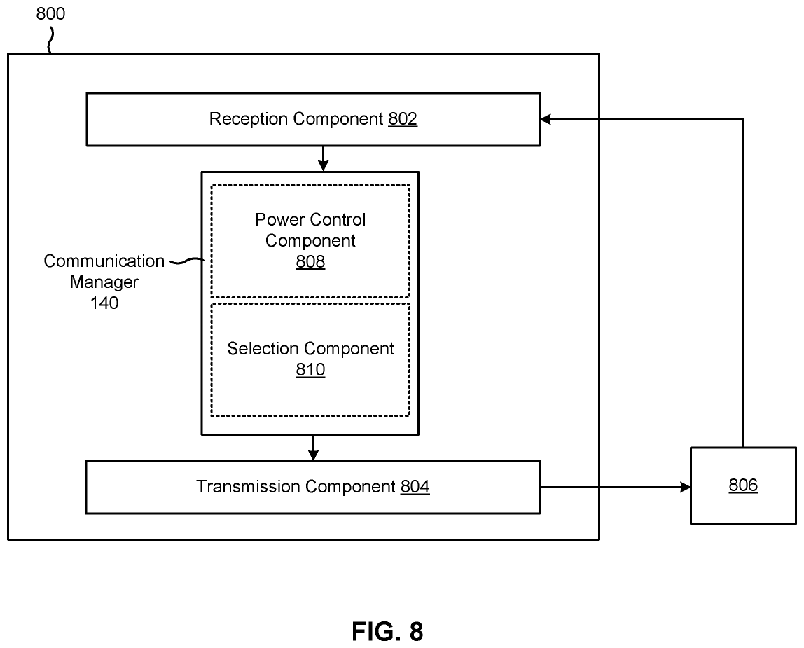

As shown in FIG. 7, in some aspects, process 700 may include allocating, from a first amount of energy associated with a first antenna group of the UE, a second amount of energy to a first antenna port of a plurality of antenna ports associated with the first antenna group (block 710). For example, the UE (e.g., using communication manager 140 and/or power control component 808, depicted in FIG. 8) may allocate, from a first amount of energy associated with a first antenna group of the UE, a second amount of energy to a first antenna port of a plurality of antenna ports associated with the first antenna group, as described above.

As further shown in FIG. 7, in some aspects, process 700 may include allocating, from the first amount of energy associated with the first antenna group of the UE, a third amount of energy to a second antenna port of the plurality of antenna ports associated with the first antenna group, wherein the second amount of energy and the third amount of energy are different from one another (block 720). For example, the UE (e.g., using communication manager 140 and/or power control component 808, depicted in FIG. 8) may allocate, from the first amount of energy associated with the first antenna group of the UE, a third amount of energy to a second antenna port of the plurality of antenna ports associated with the first antenna group, wherein the second amount of energy and the third amount of energy are different from one another, as described above.

As further shown in FIG. 7, in some aspects, process 700 may include selecting, based at least in part on the second amount of energy and the third amount of energy, a set of antenna ports, of the plurality of antenna ports, for an uplink transmission (block 730). For example, the UE (e.g., using communication manager 140 and/or selection component 810, depicted in FIG. 8) may select, based at least in part on the second amount of energy and the third amount of energy, a set of antenna ports, of the plurality of antenna ports, for an uplink transmission, as described above.

As further shown in FIG. 7, in some aspects, process 700 may include performing the uplink transmission using the selected set of antenna ports (block 740). For example, the UE (e.g., using communication manager 140 and/or transmission component 804, depicted in FIG. 8) may perform the uplink transmission using the selected set of antenna ports, as described above. In some aspects, the selected set of antenna ports may include two antenna ports, and the uplink transmission may use a rank of 1.

Process 700 may include additional aspects, such as any single aspect or any combination of aspects described below and/or in connection with one or more other processes described elsewhere herein.

In a first aspect, the selected set of antenna ports includes the first antenna port and the second antenna port, and transmitting using the set of selected antenna ports further comprises transmitting using a maximum transmit power for the first antenna port and the second antenna port, wherein the maximum transmit power is based at least in part on a first exposure factor associated with the first antenna port and a second exposure factor associated with the second antenna port.

In a second aspect, alone or in combination with the first aspect, the maximum transmit power is based at least in part on whether the first antenna port and the second antenna port are associated with the same antenna group, and based at least in part on the second amount of energy and the third amount of energy.

In a third aspect, alone or in combination with one or more of the first and second aspects, the second amount of energy and the third amount of energy are configured such that the maximum transmit power is the same for the first antenna port and the second antenna port.

In a fourth aspect, alone or in combination with one or more of the first through third aspects, the selected set of antenna ports includes the first antenna port and a third antenna port associated with a second antenna group, and the first antenna port and the third antenna port are selected based at least in part on a maximum transmit power associated with the first antenna port and a maximum transmit power associated with the third antenna port, and based at least in part on a joint energy allocation of the first antenna port and the third antenna port.

In a fifth aspect, alone or in combination with one or more of the first through fourth aspects, transmitting using the set of selected antenna ports further comprises transmitting a multiple-input multiple-output (MIMO) communication using the selected set of antenna ports.

In a sixth aspect, alone or in combination with one or more of the first through fifth aspects, transmitting using the set of selected antenna ports comprises transmitting using a first port of the set of selected antenna ports and a second port of the set of antenna ports in sequence.

In a seventh aspect, alone or in combination with one or more of the first through sixth aspects, the selection of the set of antenna ports is based at least in part on at least one of the first amount of energy or an amount of energy allocated to the second antenna group.

In an eighth aspect, alone or in combination with one or more of the first through seventh aspects, the second amount of energy and the third amount of energy are allocated per band.

In a ninth aspect, alone or in combination with one or more of the first through eighth aspects, the second amount of energy and the third amount of energy are determined in real time.

In a tenth aspect, alone or in combination with one or more of the first through ninth aspects, an amount of energy, of the first amount of energy, is reserved for communications associated with a threshold priority value, and the amount of energy is based at least in part on whether the first antenna group is a serving antenna group of the UE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include one or more of a power control component 808 or a selection component 810, among other examples.

In some aspects, the apparatus 800 may be configured to perform one or more operations described herein in connection with FIGS. 3-6. Additionally, or alternatively, the apparatus 800 may be configured to perform one or more processes described herein, such as process 700 of FIG. 7, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The power control component 808 may allocate, from a first amount of energy associated with a first antenna group of the UE, a second amount of energy to a first antenna port of a plurality of antenna ports associated with the first antenna group. The power control component 808 may allocate, from the first amount of energy associated with the first antenna group of the UE, a third amount of energy to a second antenna port of the plurality of antenna ports associated with the first antenna group, wherein the second amount of energy and the third amount of energy are different from one another. The selection component 810 may select, based at least in part on the second amount of energy and the third amount of energy, a set of antenna ports, of the plurality of antenna ports, for an uplink transmission. The transmission component 804 may perform the uplink transmission using the selected set of antenna ports.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: allocating, from a first amount of energy associated with a first antenna group of the UE, a second amount of energy to a first antenna port of a plurality of antenna ports associated with the first antenna group; allocating, from the first amount of energy associated with the first antenna group of the UE, a third amount of energy to a second antenna port of the plurality of antenna ports associated with the first antenna group, wherein the second amount of energy and the third amount of energy are different from one another; selecting, based at least in part on the second amount of energy and the third amount of energy, a set of antenna ports, of the plurality of antenna ports, for an uplink transmission; and performing the uplink transmission using the selected set of antenna ports.

Aspect 2: The method of Aspect 1, wherein the selected set of antenna ports includes the first antenna port and the second antenna port, and wherein transmitting using the set of selected antenna ports further comprises: transmitting using a maximum transmit power for the first antenna port and the second antenna port, wherein the maximum transmit power is based at least in part on a first exposure factor associated with the first antenna port and a second exposure factor associated with the second antenna port.

Aspect 3: The method of Aspect 2, wherein the maximum transmit power is based at least in part on whether the first antenna port and the second antenna port are associated with the same antenna group, and based at least in part on the second amount of energy and the third amount of energy.

Aspect 4: The method of Aspect 3, wherein the second amount of energy and the third amount of energy are configured such that the maximum transmit power is the same for the first antenna port and the second antenna port.

Aspect 5: The method of any of Aspects 1-4, wherein the selected set of antenna ports includes the first antenna port and a third antenna port associated with a second antenna group, and wherein the first antenna port and the third antenna port are selected based at least in part on a maximum transmit power associated with the first antenna port and a maximum transmit power associated with the third antenna port, and based at least in part on a joint energy allocation of the first antenna port and the third antenna port.

Aspect 6: The method of any of Aspects 1-5, wherein transmitting using the set of selected antenna ports further comprises transmitting a multiple-input multiple-output (MIMO) communication using the selected set of antenna ports.

Aspect 7: The method of any of Aspects 1-6, wherein transmitting using the set of selected antenna ports comprises transmitting using a first port of the set of selected antenna ports and a second port of the set of antenna ports in sequence.

Aspect 8: The method of Aspect 7, wherein the selection of the set of antenna ports is based at least in part on at least one of the first amount of energy or an amount of energy allocated to the second antenna group.

Aspect 9: The method of any of Aspects 1-8, wherein the second amount of energy and the third amount of energy are allocated per band.

Aspect 10: The method of Aspect 9, wherein second amount of energy and the third amount of energy are determined in real time.

Aspect 11: The method of any of Aspects 1-10, wherein an amount of energy, of the first amount of energy, is reserved for communications associated with a threshold priority value, and wherein the amount of energy is based at least in part on whether the first antenna group is a serving antenna group of the UE.

Aspect 12: An apparatus for wireless communication at a device, comprising a processor; memory coupled with the processor; and instructions stored in the memory and executable by the processor to cause the apparatus to perform the method of one or more of Aspects 1-11.

Aspect 13: A device for wireless communication, comprising a memory and one or more processors coupled to the memory, the one or more processors configured to perform the method of one or more of Aspects 1-11.

Aspect 14: An apparatus for wireless communication, comprising at least one means for performing the method of one or more of Aspects 1-11.

Aspect 15: A non-transitory computer-readable medium storing code for wireless communication, the code comprising instructions executable by a processor to perform the method of one or more of Aspects 1-11.

Aspect 16: A non-transitory computer-readable medium storing a set of instructions for wireless communication, the set of instructions comprising one or more instructions that, when executed by one or more processors of a device, cause the device to perform the method of one or more of Aspects 1-11.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
allocate, from a first amount of energy associated with a first antenna group of the UE, a second amount of energy to a first antenna port of a plurality of antenna ports associated with the first antenna group;
allocate, from the first amount of energy associated with the first antenna group of the UE, a third amount of energy to a second antenna port of the plurality of antenna ports associated with the first antenna group, wherein the second amount of energy and the third amount of energy are different from one another;
select, based at least in part on the second amount of energy and the third amount of energy, a set of antenna ports, of the plurality of antenna ports, for an uplink transmission; and
perform the uplink transmission using the selected set of antenna ports.

2. The UE of claim 1, wherein the selected set of antenna ports includes the first antenna port and the second antenna port, and wherein the one or more processors, to transmit using the set of selected antenna ports, are configured to:
transmit using a maximum transmit power for the first antenna port and the second antenna port, wherein the maximum transmit power is based at least in part on a first exposure factor associated with the first antenna port and a second exposure factor associated with the second antenna port.

3. The UE of claim 2, wherein the maximum transmit power is based at least in part on whether the first antenna port and the second antenna port are associated with a same antenna group, and based at least in part on the second amount of energy and the third amount of energy.

4. The UE of claim 3, wherein the second amount of energy and the third amount of energy are configured such that the maximum transmit power is the same for the first antenna port and the second antenna port.

5. The UE of claim 1, wherein the selected set of antenna ports includes the first antenna port and a third antenna port associated with a second antenna group, and wherein the first antenna port and the third antenna port are based at least in part on a maximum transmit power associated with the first antenna port and a maximum transmit power associated with the third antenna port, and based at least in part on a joint energy allocation of the first antenna port and the third antenna port.

6. The UE of claim 5, wherein the one or more processors are further configured to perform physical uplink control channel prioritization for the first antenna group and the second antenna group.

7. The UE of claim 1, wherein the selected set of antenna ports includes the first antenna port and the second antenna port, and wherein the first antenna port and the second antenna port are selected based at least in part on a joint energy allocation of the first antenna port and the second antenna port.

8. The UE of claim 1, wherein the one or more processors, to transmit using the set of selected antenna ports, are configured to transmit a multiple-input multiple-output (MIMO) communication using the selected set of antenna ports.

9. The UE of claim 1, wherein the one or more processors, to transmit using the set of selected antenna ports, are configured to transmit using a first port of the set of selected antenna ports and a second port of the set of antenna ports in sequence.

10. The UE of claim 9, wherein the selection of the set of antenna ports is based at least in part on at least one of the first amount of energy or an amount of energy allocated to a second antenna group.

11. The UE of claim 1, wherein the second amount of energy and the third amount of energy are allocated per band.

12. The UE of claim 11, wherein the second amount of energy and the third amount of energy are determined in real time.

13. The UE of claim 1, wherein an amount of energy, of the first amount of energy, is reserved for communications associated with a threshold priority value, and wherein the amount of energy is based at least in part on whether the first antenna group is a serving antenna group of the UE.

14. The UE of claim 1, wherein the one or more processors, to perform the uplink transmission, are configured to prioritize a physical uplink control channel on each antenna group or carrier used for the uplink transmission.

15. The UE of claim 1, wherein the one or more processors, to perform the uplink transmission using the selected set of antenna ports, are configured to perform the uplink transmission using an equalized transmit power for each antenna port of the set of antenna ports.

16. The UE of claim 15, wherein the equalized transmit power is based at least in part on a joint energy allocation of the set of antenna ports.

17. A method of wireless communication performed by a user equipment (UE), comprising:
allocating, from a first amount of energy associated with a first antenna group of the UE, a second amount of energy to a first antenna port of a plurality of antenna ports associated with the first antenna group;
allocating, from the first amount of energy associated with the first antenna group of the UE, a third amount of energy to a second antenna port of the plurality of antenna ports associated with the first antenna group, wherein the second amount of energy and the third amount of energy are different from one another;
selecting, based at least in part on the second amount of energy and the third amount of energy, a set of antenna ports, of the plurality of antenna ports, for an uplink transmission; and
performing the uplink transmission using the selected set of antenna ports.

18. The method of claim 17, wherein the selected set of antenna ports includes the first antenna port and the second antenna port, and wherein transmitting using the set of selected antenna ports further comprises:
transmitting using a maximum transmit power for the first antenna port and the second antenna port, wherein the maximum transmit power is based at least in part on a first exposure factor associated with the first antenna port and a second exposure factor associated with the second antenna port.

19. The method of claim 18, wherein the maximum transmit power is based at least in part on whether the first antenna port and the second antenna port are associated with a same antenna group, and based at least in part on the second amount of energy and the third amount of energy.

20. The method of claim 19, wherein the second amount of energy and the third amount of energy are configured such that the maximum transmit power is the same for the first antenna port and the second antenna port.

21. The method of claim 17, wherein the selected set of antenna ports includes the first antenna port and a third antenna port associated with a second antenna group, and wherein the first antenna port and the third antenna port are selected based at least in part on a maximum transmit power associated with the first antenna port and a maximum transmit power associated with the third antenna port, and based at least in part on a joint energy allocation of the first antenna port and the third antenna port.

22. The method of claim 21, further comprising performing physical uplink control channel prioritization for the first antenna group and the second antenna group.

23. The method of claim 17, wherein the selected set of antenna ports includes the first antenna port and the second antenna port, and wherein the first antenna port and the second antenna port are selected based at least in part on a joint energy allocation of the first antenna port and the second antenna port.

24. The method of claim 17, wherein transmitting using the set of selected antenna ports further comprises transmitting a multiple-input multiple-output (MIMO) communication using the selected set of antenna ports.

25. The method of claim 17, wherein transmitting using the set of selected antenna ports comprises transmitting using a first port of the set of selected antenna ports and a second port of the set of antenna ports in sequence.

26. The method of claim 25, wherein the selection of the set of antenna ports is based at least in part on at least one of the first amount of energy or an amount of energy allocated to a second antenna group.

27. The method of claim 17, wherein the second amount of energy and the third amount of energy are allocated per band.

28. The method of claim 27, wherein the second amount of energy and the third amount of energy are determined in real time.

29. A non-transitory computer-readable medium storing a set of instructions for wireless communication, the set of instructions comprising:
one or more instructions that, when executed by one or more processors of a user equipment (UE), cause the UE to:
allocate, from a first amount of energy associated with a first antenna group of the UE, a second amount of energy to a first antenna port of a plurality of antenna ports associated with the first antenna group;
allocate, from the first amount of energy associated with the first antenna group of the UE, a third amount of energy to a second antenna port of the plurality of antenna ports associated with the first antenna group, wherein the second amount of energy and the third amount of energy are different from one another;
select, based at least in part on the second amount of energy and the third amount of energy, a set of antenna ports, of the plurality of antenna ports, for an uplink transmission; and
perform the uplink transmission using the selected set of antenna ports.

30. An apparatus for wireless communication, comprising:
means for allocating, from a first amount of energy associated with a first antenna group of the apparatus, a second amount of energy to a first antenna port of a plurality of antenna ports associated with the first antenna group;
means for allocating, from the first amount of energy associated with the first antenna group of the apparatus, a third amount of energy to a second antenna port of the plurality of antenna ports associated with the first antenna group, wherein the second amount of energy and the third amount of energy are different from one another;
means for selecting, based at least in part on the second amount of energy and the third amount of energy, a set of antenna ports, of the plurality of antenna ports, for an uplink transmission; and
means for performing the uplink transmission using the selected set of antenna ports.
